(19) United States
(12) Patent Application Publication
(10) Pub. No.: US 2010/0073980 A1
(43) Pub. Date: Mar. 25, 2010

(54) POWER CONVERTER ASSEMBLY WITH ISOLATED GATE DRIVE CIRCUIT

(75) Inventors: SEOK-JOO JANG, IRVINE, CA (US); CHRISTOPHER P. HENZE, LAKEVILLE, MN (US); GEORGE R. WOODY, REDONDO BEACH, CA (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/235,708

(22) Filed: Sep. 23, 2008

(51) Int. Cl. H02M 7/537

(52) U.S. Cl. 363/131

(57) ABSTRACT

A power converter assembly is provided. The power converter includes at least one switch, a high frequency oscillator coupled to the at least one switch and configured to generate a high frequency waveform based on direct current (DC) power provided thereto, and a power buffer coupled to the at least one switch and the high frequency oscillator and configured to control the operation of the at least one switch based on the high frequency waveform

### TECHNICAL FIELD

The present invention generally relates to power converters, and more particularly relates to an automotive power converter with an isolated gate drive circuit.

### BACKGROUND OF THE INVENTION

In recent years, advances in technology, as well as ever-evolving tastes in style, have led to substantial changes in the design of automobiles. One of the changes involves the complexity of the electrical systems within automobiles, particularly alternative fuel vehicles, such as hybrid, electric, and fuel cell vehicles. Such alternative fuel vehicles typically use one or more electric motors, perhaps in combination with another actuator, to drive the wheels. Additionally, such automobiles may also include other motors, as well as other high voltage components, to operate the other various systems within the automobile, such as the air conditioner.

Due to the fact that alternative fuel automobiles typically include only direct current (DC) power supplies, direct current-to-alternating current (DC/AC) inverters (or power inverters) are provided to convert the DC power to alternating current (AC) power, which is generally required by the motors. Such vehicles, particularly fuel cell vehicles, also often use two separate voltage sources, such as a battery and a fuel cell, to power the electric motors that drive the wheels. Thus, power converters, such as direct current-to-direct current (DC/DC) converters, are typically also provided to manage and transfer the power from the two voltage sources.

It is desirable to provide a power converter with improved performance as related to the characteristics described above, as well as a layout that allows for advanced thermal management. Furthermore, other desirable features and characteristics of the present invention will become apparent from the subsequent description taken in conjunction with the accompanying drawings and the foregoing technical field and background.

### SUMMARY OF THE INVENTION

A power converter assembly is provided. The power converter includes at least one switch, a high frequency oscillator coupled to the at least one switch and configured to generate a high frequency waveform based on direct current (DC) power provided thereto, and a power buffer coupled to the at least one switch and the high frequency oscillator and configured to control the operation of the at least one switch based on the high frequency waveform.

An automotive power converter assembly is provided. The automotive power converter includes at least one transistor, a substrate comprising a plurality of ceramic layers and passive electronic components, the passive electronic components at least partially forming a high frequency oscillator coupled to the at least one transistor and configured to generate a high frequency waveform based on direct current (DC) power provided thereto, and a power buffer coupled to the at least one transistor and the high frequency oscillator, the power buffer being configured to control the operation of the at least one transistor based on the high frequency waveform

An automotive drive system is provided. The automotive drive system includes an electric motor, a power inverter coupled to the electric motor and comprising at least one switch, a direct current (DC) power supply configured to generate DC power, a high frequency oscillator coupled to the DC power supply and configured to generate a high frequency waveform based on the DC power, control circuitry configured to generate a control signal, and a power buffer coupled to the high frequency oscillator, the control circuitry, and the power inverter and configured to control the operation of the at least one switch within the power inverter based on the high frequency waveform and the control signal such that alternating current (AC) power is provided to the electric motor.

### DESCRIPTION OF THE DRAWINGS

The present invention will hereinafter be described in conjunction with the following drawing figures, wherein like numerals denote like elements, and

FIG. 1 is a schematic view of an exemplary automobile according to one embodiment of the present invention;

FIG. 2 is a block diagram of a voltage source inverter system within the automobile of FIG. 1;

FIG. 3 is a schematic view of an inverter within the automobile of FIG. 1;

FIG. 4 is a block diagram of an inverter gate drive power and logic control circuit, according to one embodiment of the present invention; and

FIG. 5 is a cross-sectional side view of a ceramic circuit substrate in which the circuit of FIG. 4 may be at least partially implemented.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, and brief summary, or the following detailed description.

The following description refers to elements or features being “connected” or “coupled” together. As used herein, “connected” may refer to one element/feature being mechanically joined to (or directly communicating with) another element/feature, and not necessarily directly. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

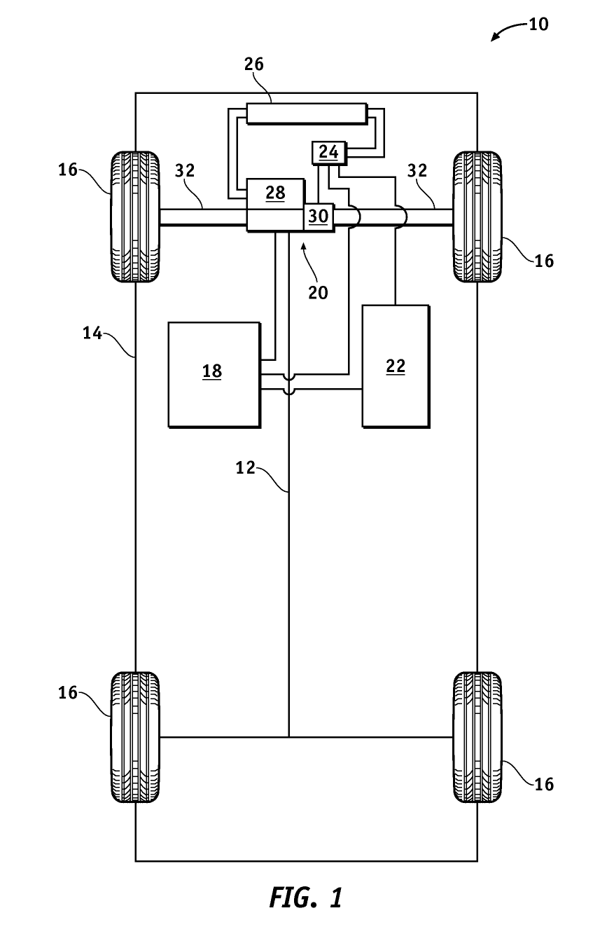

Further, various components and features described herein may be referred to using particular numerical descriptors, such as first, second, third, etc., as well as positional and/or angular descriptors, such as horizontal and vertical. However, such descriptors may be used solely for descriptive purposes relating to drawings and should not be construed as limiting, as the various components may be rearranged in other embodiments. It should also be understood that FIGS. 1-5 are merely illustrative and may not be drawn to scale.

FIG. 1 to FIG. 5 illustrate an automotive power converter assembly. The power converter includes at least one switch, a high frequency oscillator coupled to the at least one switch and configured to generate a high frequency waveform based on direct current (DC) power provided thereto, and a power buffer coupled to the at least one switch and the high frequency oscillator and configured to control the operation of the at least one switch based on the high frequency waveform. The high frequency oscillator may be formed at least partially within a ceramic substrate, such as a low temperature co-fired ceramic (LTCC) substrate, which allows the waveform to have a very high frequency (e.g., over 100 megahertz (MHz)) and facilitates a reduction in size of the gate drive circuitry.

FIG. 1 illustrates a vehicle (or “automobile”) 10, according to one embodiment of the present invention. The automobile 10 includes a chassis 12, a body 14, four wheels 16, and an electronic control system 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The automobile 10 may also incorporate any one of, or combination of, a number of different types of engines, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

In the exemplary embodiment illustrated in FIG. 1, the automobile 10 is a hybrid vehicle, and further includes an actuator assembly 20, a battery (or a high voltage direct current (DC) power supply) 22, a power converter assembly (e.g., an inverter assembly) 24, and a radiator 26. The actuator assembly 20 includes a combustion engine 28 and an electric motor/generator (or motor) 30. As will be appreciated by one skilled in the art, the electric motor 30 includes a transmission therein, and although not illustrated also includes a stator assembly (including conductive coils), a rotor assembly (including a ferromagnetic core), and a cooling fluid (i.e., coolant). The stator assembly and/or the rotor assembly within the electric motor 30 may include multiple electromagnetic poles (e.g., sixteen poles), as is commonly understood.

Still referring to FIG. 1, in one embodiment, the combustion engine 28 and the electric motor 30 are integrated such that both are mechanically coupled to at least some of the wheels 16 through one or more drive shafts 32. The radiator 26 is connected to the frame at an outer portion thereof and although not illustrated in detail, includes multiple cooling channels therein that contain a cooling fluid (i.e., coolant) such as water and/or ethylene glycol (i.e., “antifreeze”) and is coupled to the engine 28 and the inverter 24. Although the discussion below refers to the power converter assembly 24, as a direct current-to-alternating current (DC/AC) inverter (i.e., a DC-to-AC inverter), it should be understood that in other embodiments, aspects of the present invention may be used in conjunction with direct current-to-direct current (DC/DC) converters, as will be appreciated by one skilled in the art.

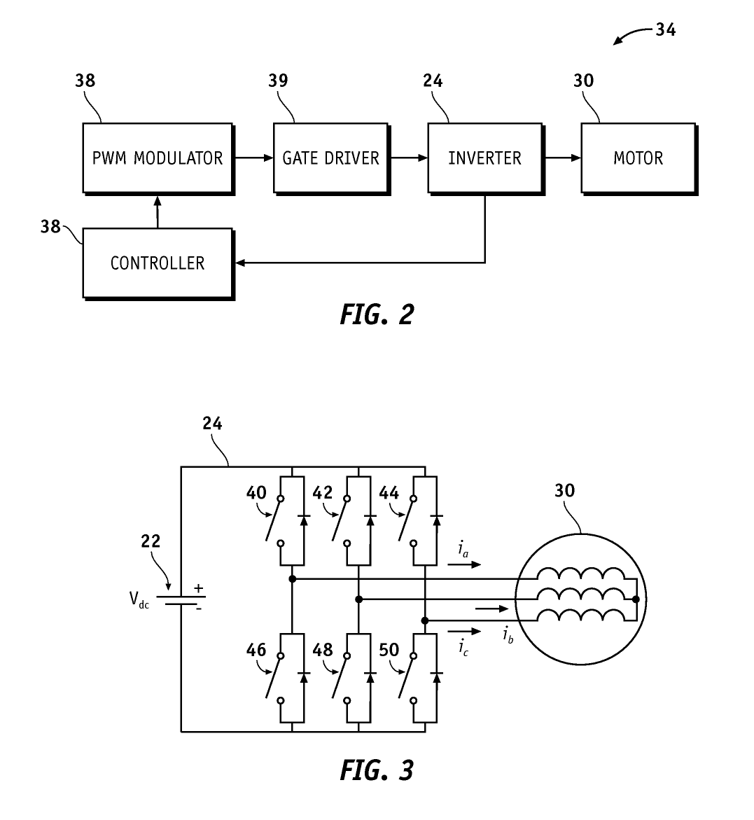

Referring to FIG. 2, a voltage source inverter system (or electric drive system) 34, in accordance with an exemplary embodiment of the present invention, is shown. The voltage source inverter system 34 includes a controller 36 in operable communication with a Pulse Width Modulation (PWM) modulator 38 (or a pulse width modulator) and the inverter 24 (at an output thereof). The PWM modulator 38 is coupled to a gate driver 39, which in turn has an input coupled to an input of the inverter 24. The inverter 24 has a second output coupled to the motor 30. The controller 36 and the PWM modulator 38 may be integral with the electronic control system 18 shown in FIG. 1.

FIG. 3 schematically illustrates the inverter 24 (or power converter) of FIGS. 1 and 2 in greater detail. The inverter 24 includes a three-phase circuit coupled to the motor 30. More specifically, the inverter 24 includes a switch network having a first input coupled to a voltage source Vdc (e.g., the battery 22) and an output coupled to the motor 30. Although a single voltage source is shown, a distributed DC link with two series sources may be used.

The switch network comprises three pairs (a, b, and c) of series switches with antiparallel diodes (i.e., antiparallel to each switch) corresponding to each of the phases of the motor 30. Each of the pairs of series switches comprises a first switch, or transistor, (i.e., a “high” switch) 40, 42, and 44 having a first terminal coupled to a positive electrode of the voltage source 22 and a second switch (i.e., a “low” switch) 46, 48, and 50 having a second terminal coupled to a negative electrode of the voltage source 22 and a first terminal coupled to a second terminal of the respective first switch 40, 42, and 44. As is commonly understood, each of the switches 40-50 may be in the form of individual semiconductor devices such as insulated gate bipolar transistors (IGBTs) within integrated circuits formed on semiconductor (e.g. silicon) substrates (e.g., die).

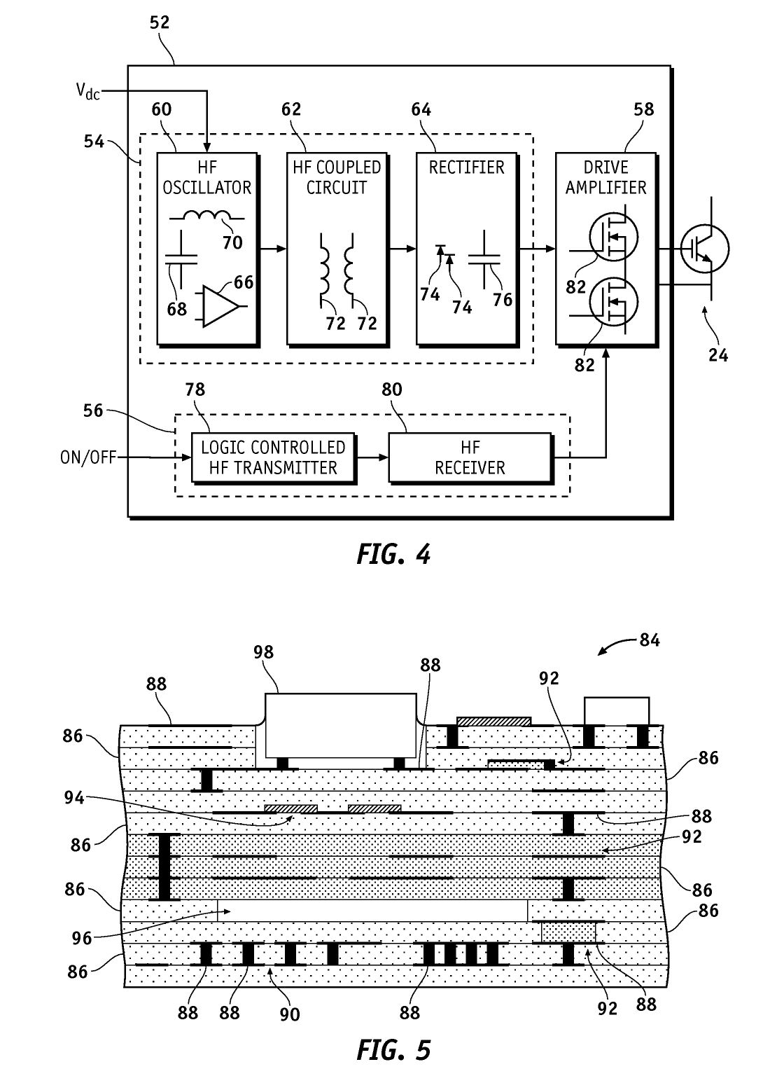

FIG. 4 illustrates a power switching transistor gate drive power and logic control circuit (or subsystem) 52, according to one embodiment of the present invention. The subsystem 52 includes power supply circuitry (or a power supply) 54, logic control circuitry 56, and a power buffer (or drive amplifier) 58. As will be appreciated by one skilled in the art, the subsystem 52 corresponds to the gate driver 39 (FIG. 2) and is used to drive switches 40-50 (FIG. 3) within the inverter 24 (shown symbolically with a switch in FIG. 4).

The power supply 54 includes a high frequency (HF) oscillator 60, a HF coupled circuit 62, and a rectifier 64. The HF oscillator 60 includes an integrated circuit 66 configured to control the HF oscillator 60 to keep the operation thereof at the resonant frequency of an LC circuit formed by a capacitor 68 and an inductor 70 within the HF oscillator 60. Through the LC circuit, the HF oscillator 60 delivers high frequency AC power to the HF coupled circuit 62. In one embodiment, the oscillator is a resonant cavity oscillator and likewise also includes a resonator cavity, as is commonly understood. The HF coupled circuit 62 includes two coils 72 which jointly form a transformer. In one embodiment, the transformer does not include a ferromagnetic core within either of the coils 72. The rectifier 64 (e.g., 20 VDC) includes one or more (e.g., two) diodes 74 and one or more (e.g., two) capacitors 76. In one embodiment, the power to operate the power supply 54 (V_{dc}) is provided by a low voltage (e.g., 12V) battery (not shown), as the high voltage battery, 22, is electrically isolated from the low voltage system.

The logic control circuitry 56 includes an HF electromagnetic transmitter 78 and an HF electromagnetic receiver 80. Although not shown, the transmitter 78 and the receiver 80 may include various passive electronic components, such as inductors, resistors, capacitors, and diodes, as is commonly understood. The logic control circuitry 56 may serve, at least in part, to electrically isolate the control or switching signal (ON/OFF) from the high voltage and to deliver the signal to the drive amplifier.

The power buffer (or drive amplifier) 58, in one embodiment, includes one or more (e.g., two) metal-oxide-semiconductor field-effect transistors (MOSFETs) 82 that are in operable communication with (or electrically connected to) the rectifier 64 and the HF receiver 80, as is commonly understood. The MOSFETs 82 are also electrically connected to the inverter 24 (and/or one of the switches in the inverter 24). As will be appreciated by one skilled in the art, other devices that are capable of delivering sufficiently high peak current for the switching action of the inverter 24 (i.e., switches 40-50 in FIG. 3) may be used other than MOSFETs.

In one embodiment, various components of the inverter gate drive power and logic control subsystem 52 are implemented within a multi-layer ceramic substrate, such as a low temperature co-fired ceramic (LTCC) substrate 84, an example of which is shown in FIG. 5. As will be appreciated by one skilled in the art, the substrate 84 includes multiple dielectric layers 86 which include conductive members 88 (e.g., vias and traces) that are formed therein. The conductive members 88 may be formed by punching or drilling holes through individual layers 86 (e.g., glass ceramic tape) and adding metallization for the members 88 into the holes using, for example, screenprinting or photo-imaging methods. The layers 86 are then stacked and laminated before being fired at, for example, between 850° and 900° C. The structure is then cut to size to form the substrate 84.

Referring to FIGS. 4 and 5 in combination, the layers 86 may be configured such they, with the conductive members 88, jointly form some (or all) of the passive electronic components of the subsystem 52, such as inductors 90, capacitors 92, and resistors 94, within the substrate 84. Additionally, one of the layers 86 may include a resonant cavity 96 (for the oscillator 60 (FIG. 4). Other components, such as integrated circuits 98 (such as the integrated circuit 66 of the oscillator 60 and/or the drive amplifier 58), diodes 100, and printed resistors 102 may be mounted to (or formed on) an upper surface of the substrate 84. As such, the HF oscillator 60, the HF coupled circuit 62, the rectifier 64, the HF transmitter 78, and the HF receiver 80 are at least partially formed within (or are at least partially integral with) the substrate 84. Therefore, in at least one embodiment, the entire inverter gate drive power and logic control subsystem 52 is implemented within and/or on a single component (i.e., the substrate 84).

Referring again to FIG. 1, in the depicted embodiment, the inverter 24 receives and shares coolant with the electric motor 30. The radiator 26 may be similarly connected to the inverter 24 and/or the electric motor 30. The electronic control system 18 is in operable communication with the actuator assembly 20, the high voltage battery 22, and the inverter assembly 24. Although not shown in detail, the electronic control system 18 includes various sensors and automotive control modules, or electronic control units (ECUs), such as an inverter control module and a vehicle controller, and at least one processor and/or a memory which includes instructions stored thereon (or in another computer-readable medium) for carrying out the processes and methods as described below. It should also be understood that the electronic control system 18 may include, or be integral with, portions of the inverter assembly 24 shown in FIG. 2, such as the controller 36 and the modulator 38.

During operation, referring to FIGS. 1 and 2, the automobile 10 is operated by providing power to the wheels 16 with the combustion engine 28 and the electric motor 30 in an alternating manner and/or with the combustion engine 28 and the electric motor 30 simultaneously. In order to power the electric motor 30, DC power is provided from the battery 22 (and, in the case of a fuel cell automobile, a fuel cell) to the inverter 24, which converts the DC power into AC power, before the power is sent to the electric motor 30. As will be appreciated by one skilled in the art, the conversion of DC power to AC power is substantially performed by operating (i.e., repeatedly switching) the transistors 33 within the inverter 24 at a “switching frequency” (F_{sw}), such as, for example, 12 kilohertz (kHz). Generally, the controller 36 produces a Pulse Width Modulation (PWM) signal for controlling the switching action of the inverter 24. In a preferred embodiment, the controller 36 preferably produces a discontinuous PWM (DPWM) signal having a single zero vector associated with each switching cycle of the inverter 24. The inverter 24 then converts the PWM signal to a modulated voltage waveform for operating the motor 30.

Referring to FIG. 4, a high voltage power signal (V_{dc}) is received by the HF oscillator 60 from the battery 22. The HF oscillator 60 generates an HF AC waveform (or power signal) with a frequency of, for example, between 100 megahertz (MHz) and 1 gigahertz (GHz), or higher. The AC waveform is provided to the HF coupled circuit 62 where the transformer formed by the inductors 72 reduces the voltage of the signal before it is converted into a single polarity by the rectifier 64. The signal is then provided to the power buffer 58, which uses the power signal, along with a control signal (ON/OFF) that is initially generated by the inverter module within the electronic control system 18 (FIG. 1) and received from the logic control circuitry 56, to operate the inverter 24 (i.e., the switching of the transistors within the inverter 24).

One advantage is that the use of the HF oscillator allows for the AC waveform to be generated at significantly higher frequencies, which in turn allows for a significant reduction in the size of the passive components (and the substrate overall). As a result, the distance between the circuitry used to drive the gates of the transistors and the inverter itself (i.e., the transistors) may be reduced. This reduction in size, in some embodiments, may allow the gate drive circuitry to be located within, and implemented as part of, one of the inverter modules, resulting in a reduction of external components and the wiring harnesses required between components.

The gate drive circuit described above may be used in various types of systems other than inverters used for motor drive, as it may be used in any application with a power switching transistor. For example, the circuit may be used in direct current-to-direct current (DC/DC) converters, such as boost converters, and it may be used to drive a single switch chopper that controls a heating element.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A power converter assembly comprising:
at least one switch;
a high frequency oscillator coupled to the at least one switch and configured to generate a high frequency waveform based on direct current (DC) power provided thereto; and
a power buffer coupled to the at least one switch and the high frequency oscillator and configured to control the operation of the at least one switch based on the high frequency waveform.

2. The power converter assembly of claim 1, further comprising a substrate comprising a plurality of ceramic layers and conductive members and wherein the high frequency oscillator is integral with the substrate.

3. The power converter assembly of claim 2, wherein the conductive members within the substrate jointly form a plurality of passive electronic components.

4. The power converter assembly of claim 3, further comprising a transformer and a rectifier that are integral with the substrate, and wherein the high frequency oscillator, the transformer, and the rectifier are at least partially formed by the plurality of passive electronic components.

5. The power converter assembly of claim 4, wherein the substrate is a low temperature co-fired ceramic (LTCC) substrate.

6. The power converter assembly of claim 5, further comprising control circuitry coupled to the power buffer and configured to provide a control signal thereto, and wherein the power buffer is further configured to control the operation of the at least one switch based on the high frequency waveform and the control signal.

7. The power converter assembly of claim 6, wherein the high frequency waveform has a frequency greater than 1 megahertz (MHz).

8. The power converter assembly of claim 7, wherein the automotive power converter assembly is configured to convert the DC power to alternating current (AC) power.

9. The power converter assembly of claim 6, wherein the control circuitry comprises a transmitter and a receiver, and wherein at least a portion of each of the transmitter and the receiver is at least partially formed by the passive electronic components.

10. The power converter assembly of claim 9, wherein the transmitter is an electromagnetic transmitter and the receiver is an electromagnetic receiver.

11. An automotive power converter assembly comprising:
at least one transistor;
a substrate comprising a plurality of ceramic layers and passive electronic components, the passive electronic components at least partially forming a high frequency oscillator coupled to the at least one transistor and configured to generate a high frequency waveform based on direct current (DC) power provided thereto; and
a power buffer coupled to the at least one transistor and the high frequency oscillator, the power buffer being configured to control the operation of the at least one transistor based on the high frequency waveform.

12. The automotive power converter assembly of claim 11, wherein the substrate is a low temperature co-fired ceramic (LTCC) substrate.

13. The automotive power converter assembly of claim 12, further comprising control circuitry coupled to the power buffer and configured to provide a control signal to the power buffer, and wherein the power buffer further configured to control the operation of the at least transistor based on the high frequency waveform and the control signal.

14. The automotive power converter assembly of claim 13, wherein the passive electronic components within the substrate further at least partially form a transformer and a rectifier that are coupled to the high frequency oscillator and the power buffer.

15. The automotive power converter assembly of claim 14, wherein the high frequency waveform has a frequency greater than 100 megahertz (MHz).

16. An automotive drive system comprising:
an electric motor;
a power inverter coupled to the electric motor and comprising at least one switch;
a direct current (DC) power supply configured to generate DC power;
a high frequency oscillator coupled to the DC power supply and configured to generate a high frequency waveform based on the DC power;
control circuitry configured to generate a control signal; and
a power buffer coupled to the high frequency oscillator, the control circuitry, and the power inverter and configured to control the operation of the at least one switch within the power inverter based on the high frequency waveform and the control signal such that alternating current (AC) power is provided to the electric motor.

17. The automotive drive system of claim 16, further comprising a substrate comprising a plurality of ceramic layers and conductive members formed within the ceramic layers, and wherein the high frequency oscillator is at least partially formed by the conductive members.

18. The automotive drive system of claim 17, wherein the conductive members within the ceramic layers of the substrate form a plurality of passive electronic components.

19. The automotive drive system of claim 18, further comprising a transformer and a rectifier coupled to the high frequency oscillator and the power buffer, wherein the transformer and the rectifier are at least partially formed by the electronic components within the substrate.

20. The automotive drive system of claim 19, wherein the substrate is a low temperature co-fired ceramic (LTCC) substrate.
